(19) United States
(12) Patent Application Publication
(10) Pub. No.: US 2005/0110955 A1
(43) Pub. Date: May 26, 2005

(54) Projection device

(76) Inventors: Arne Trollsch, Grossschwabhausen (DE); Dirk Muhlhoff, Kunitz (DE); Markus Strehle, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/954,634

(22) Filed: Sep. 30, 2004

(30) Foreign Application Priority Data
Sep. 30, 2003 (DE) 103 45 432.2

(51) Int. Cl. G03B 21/00

(52) U.S. Cl. 353/31

(57) ABSTRACT

A projection device for projecting a multi-colored image including a light source unit emitting light of different colors, a light modulator unit, illumination optics arranged between the light source unit and the light modulator unit and directing light from the light source unit onto the light modulator unit, projection optics arranged following the light modulator unit. The projection optics project an image generated by means of the light modulator unit onto a projection surface and the light source unit includes light emitting diodes as the light-generating elements.

### FIELD OF THE INVENTION

The invention relates to a projection device for projecting a multi-colored image, comprising a light source unit emitting light of different colors, a light modulator unit, illumination optics arranged between the light source unit and the light modulator unit and directing light from the light source unit onto the light modulator unit, projection optics arranged following the light modulator unit, said projection optics projecting an image generated by means of the light modulator unit onto a projection surface.

### BACKGROUND OF THE INVENTION

In such projection devices, white-light sources, e.g. metal halide lamps or high-pressure Xe lamps, are often used as the light source. A disadvantage of these lamps consists in that, for color projection, the light has to be split up into three colors (for example, red, green and blue), which is connected with optical complexity. Further, such lamps are operated with a high voltage, which requires considerable electronic complexity for generating the required voltages (up to 12,000 V) and for current limitation. Also, such lamps require a reflector which provides a lower limit for the constructional dimensions of the projectors. Finally, the life of such lamps is relatively short, and the warming-up time of approximately 1 minute is relatively long.

It is an object of the present invention to provide a projection device for projection of a multicolor image, which is a compact device and can be manufactured with reduced expenditure.

### SUMMARY OF THE INVENTION

This object is achieved by a projection device of the above-mentioned type in that the light source unit comprises light emitting diodes as the light-generating element.

Light emitting diodes do not require complex electronics, so that a compact structure of the projection device is already achieved by this. Furthermore, light emitting diodes are relatively monochromatic light sources, so that no color splitting is required. Also, the heat developed and the energy consumed by the light emitting diodes during color-sequence operation (during which light of different colors is directed at the light modulator unit in a time sequence) is considerably lower than with conventional white-light sources. This also allows the projection device according to the invention to have a compact design.

Particularly preferably, the light emitting diodes are arranged as an array. Thus, a virtually two-dimensional light source, which emits colored light at the desired wavelength, is provided.

The light source unit may preferably comprise an array on which light emitting diodes emitting light of different colors are arranged. Thus, using one single array, it becomes possible to generate (preferably sequentially in time) light of different colors, which can then be directed at the light modulator unit. This reduces the optical complexity of the illumination optics, because only one illumination optics needs to be provided for said array.

A further embodiment of the projection device according to the invention consists in that a control unit is provided which has the effect that in each case only light from some of the light emitting diodes is used for illumination of the light modulator unit. This control unit can be provided such that, over time, light from different light emitting diodes is preferably used with different colors for illumination. Thus, energy can be saved, because in each case only the light or the color, respectively, which is currently needed is generated. Further, the heat developed by the light emitting diodes can be minimized. The light emitting diodes can be operated at stronger currents, in particular during color-sequence operation, so that more light is available to the light modulator unit.

In particular, the light emitting diodes, on the one hand, and the illumination optics, on the other hand, are movable relative to each other. This may be realized, for example, by arranging the light emitting diodes on a rotatable carrier, such as a rotatable disk. If the rotatable disk is provided, the axis of rotation of the disk is offset relative to the optical axis of the illumination optics. This has the effect that, due to the rotation of the disk, it is always different light emitting diodes that are led past the illumination optics. The control unit always switches on only those light emitting diodes which are in front of the illumination optics or whose light is directed onto the light modulator unit by the illumination optics, respectively.

Further, the light emitting diodes can be arranged on the outside of a cylinder (e.g. a drum) whose axis of rotation is perpendicular to the optical axis of the illumination optics. In this case, too, only those light emitting diodes are switched on, which are currently in front of the illumination optics during rotation of the cylinder.

Also, between the light emitting diodes and the illumination optics, there may be provided a deflecting unit which, controlled by the control unit, couples the light from different light emitting diodes into the illumination optics as time progresses. Thus, in this case, movement is effected by the deflecting unit. As the deflection unit, galvanometer mirrors or polygon scanners may be used.

A particularly preferred embodiment of the device according to the invention consists in that the light source unit comprises two light emitting diode arrays whose direction of light propagation is equal, said light emitting diode arrays being arranged behind each other, as seen in the direction of light propagation, and imaging optics are arranged between said two arrays, said imaging optics imaging the light emitting diodes of the first array between the light emitting diodes of the second array. For example, said imaging optics may be 1:1 imaging optics. This increases the effectively illuminated surface area of the second light emitting diode array and, at the same time, the heat developed is advantageously distributed between two arrays, so that the individual array, and in particular the second array, does not become too hot.

The light emitting diodes of the second array are preferably attached to a carrier plate having, between the light emitting diodes, through holes for the light from the light emitting diodes of the first array.

In a further embodiment of the projection device according to the invention, the light source unit comprises at least two light emitting diode light sources emitting light of different colors, and the illumination optics contain a combining unit which guides the light from the light emitting diode light sources in a common beam path leading to the light modulator unit. This makes it possible to provide a projection device having only one light modulator, onto which the differently colored light from the two light emitting diode light sources is directed sequentially in time. In particular, a third light emitting diode light source may also be provided, which is also directed into the common beam path by means of the combining unit. When three light emitting diode light sources are in use, it is preferred to employ light emitting diode light sources which generate the primary colors red, green and blue.

In a further embodiment of the projection device according to the invention, the light source unit comprises at least two light emitting diode light sources emitting light of different colors, and the light modulator unit contains a light modulator for each light emitting diode light source, with light from the respective light emitting diode light source being directed onto said light modulator, there being arranged, between the projection optics and the light modulators, a combining unit which guides the modulated light coming from the light modulators into a common beam path leading to the projection optics. In this embodiment, the partial color images of the image to be projected can be generated simultaneously with the individual light modulators, so that a projection is possible with a very great light intensity.

The light modulators used are preferably transmissive light modulators, such as LCD modules, for example. Of course, reflective light modulators, such as LCoS modules and tilting-mirror matrices, for example, can also be used.

A further embodiment of the projection device according to the invention consists in that the illumination optics comprise a first lens array and subsequently arranged optics having positive refractive power. In this connection, the optical distance from the first lens array to said optics and the distance from the optics to the light modulator unit preferably corresponds to the focal length of the optics. In this case, the illumination optics are provided as a honeycombed condensor system having a beam path which is telecentric on the image side and with etendue conservation.

A preferred embodiment of the projection device according to the invention consists in that the condenser system comprises, between the first lens array and the corresponding light source of the light source unit, the latter including one or more light sources (preferably light emitting diode light sources), a second lens array, with the focal points of the lenses of the second lens array preferably being located in the plane of the first lens array. The use of two lens arrays arranged following each other makes it particularly easy to adjust the homogenization to a determined aspect ratio of the surface to be illuminated in the light modulator unit, in particular if said surface to be illuminated is rectangular. Thus, for example, use can be made of two cylinder lens arrays which are rotated 90° relative to each other, so that the desired rectangular aspect ratio is easily adjustable. This is also particularly advantageous insofar as cylinder lens arrays are easy to manufacture.

The two lens arrays arranged following each other may be provided as a tandem lens array, wherein the lens arrays are arranged on the front and rear surfaces of a substrate. Thus, a very compact optical element is provided allowing the entire projection device to have a compact design. The two lens arrays are preferably equal in design and adjusted relative to each other.

Instead of two cylinder lens arrays, use may also be made of one single lens array, wherein the lenses are arranged in lines and columns, thus reducing the number of the array. Such lens array may be provided such that it has the same optical effect as two cylinder lens arrays arranged following each other, which are preferably rotated 90° relative to each other, and it may also be further embodied as a tandem lens array, of course.

It is further possible to provide an additional tandem lens array between the tandem lens array and the respective light source. In this case, both two tandem lens arrays may be provided as tandem cylinder lens arrays which are rotated relative to each other. Different lens parameters of the cylinder lens arrays of the two tandem cylinder arrays enable an optimal adjustment to the surface to be illuminated (in particular, if said surface is rectangular).

Further, the projection device according to the invention is preferably provided with a control unit which controls the light modulator unit and preferably also the light source unit on the basis of given image data.

### BRIEF DESCRIPTION OF THE DRAWINGS

The invention will be explained in more detail below, by way of example, with reference to the Figures, wherein:

FIG. 1 shows a projection device according to a first embodiment;

FIG. 2 shows a specific embodiment of the light source unit of FIG. 1;

FIG. 3 shows a projection device according to a second embodiment;

FIG. 4 shows a projection device according to a third embodiment;

FIG. 5 shows a projection device according to a fourth embodiment;

FIG. 6 shows an example of illumination optics.

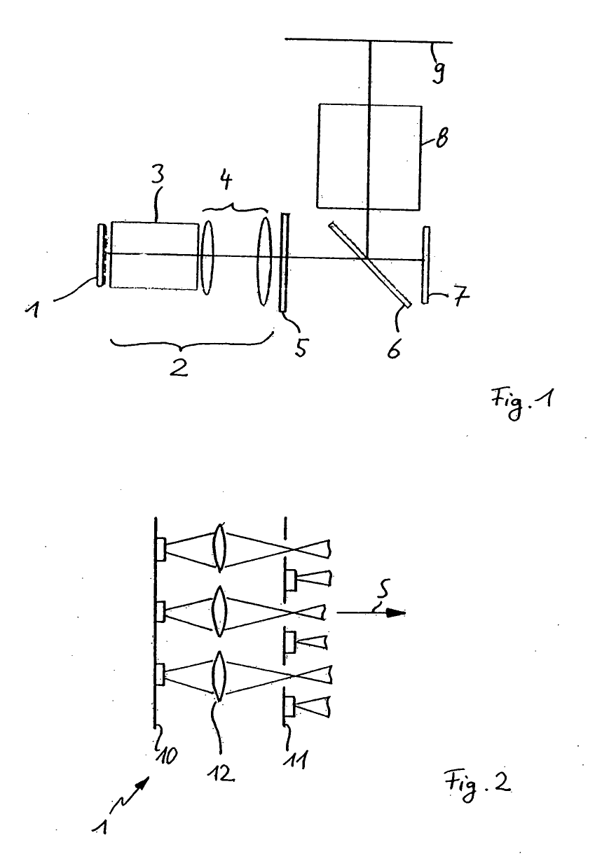

### DETAILED DESCRIPTION OF THE INVENTION

As is evident from FIG. 1, the projection device of this embodiment comprises a light source unit 1, which is provided as an light emitting diode array comprising light emitting diodes which emit red, green or blue light. Arranged following the light emitting diode array 1 are illumination optics 2 comprising beam adjustment optics 3 and a relay system 4. The beam adjustment optics 2 may be a light-mixing rod, for example, by which the desired illumination cross-section is generated. Following the illumination optics 2, there are arranged, in this order: a polarizer 5, a polarizing beam splitter 6 and a reflective LCoS module 7. Further, a projection lens 8 serving to project the image generated by means of the light modulator 7 onto a projection surface 9 is also provided. The projection device further comprises a control unit (not shown) which controls the light modulator 7 as well as the light emitting diode array 1 on the basis of given image data.

Control is effected such that, using the light emitting diode array 1, red, green and blue light are generated sequentially in time, said light being linearly pre-polarized by the polarizer in the desired direction (for example, p-polarization) 5 and then impinging on the reflective light modulator 7 through the polarization beam splitter 6. As a function of the pixel to be displayed, the light modulator 7 rotates the direction of polarization of the incident light and reflects it back in itself, so that the light either passes back through the polarizing beam splitter 6 again or is upwardly deflected by it (as seen in FIG. 1) at 90° and is then projected onto the projection surface 9 by means of the projection lens 8. This allows red, green and blue partial color images to be generated sequentially in time. This is effected so quickly in succession that a viewer can only perceive the superimposed condition of the partial color images and, thus, the multi-colored image. The use of the light emitting diodes allows the entire projection device to have a compact design. Further, in the described projection device, only those light emitting diodes whose light is actually needed at that moment are switched on in each case, so that the projection device as a whole saves a lot of energy.

If a tilting-mirror matrix is used instead of a reflective LCoS module, the polarizer 5 can be omitted and the polarizing beam splitter 6 is replaced by a partially transparent mirror or a TIR prism (total internal reflection). Said mirror or said TIR prism is then arranged such that the light reflected by the tilting mirrors of the tilting-mirror matrix which are in a first tilted position is projected onto the projection surface 9 by means of the projection lens 8, while the light reflected by the tilting mirrors which are in a second tilted position is cut off by a stop (not shown) which is arranged laterally with respect to the lens 8.

In this embodiment, the light source unit 1 comprises two light emitting diode arrays 10, 11 arranged following each other and lens optics 12 arranged therebetween. Through holes are provided between the light emitting diodes of the light emitting diode array 11, and the light emitting diodes of the light emitting diode array 10 are arranged together with the lens optics 12 in such a manner that they are imaged into said holes. Imaging by means of the microlenses 11 can be realized as 1:1 imaging in the so-called 4f arrangement. In this case, the distance from the lenses of the lens optics 12 to the two arrays 10, 11 is equal, in each case, to twice the focal length of the lenses.

FIG. 3 shows a second embodiment of the projection device. This embodiment essentially differs from the embodiment shown in FIG. 1 only by the light source unit. Therefore, the same parts are designated by the same reference numerals, and for description thereof, reference is made to the above comments.

The light source unit comprises three light emitting diode arrays 13, 14, and 15, which emit blue, green and red light, respectively. The light of the light emitting diode arrays 13 to 15 is directed to the right, as seen in FIG. 3, toward the illumination optics 2, by means of a color-combining unit 16, which comprises two color-splitting layers 17 and 18, which are perpendicular to each other and intersect one another. The subsequent beam path is the same as in the embodiment of FIG. 3. In this embodiment, a compact arrangement can be realized, at the same time allowing great brightness in the displayed image, because one array 13, 14, 15 is always provided for one color.

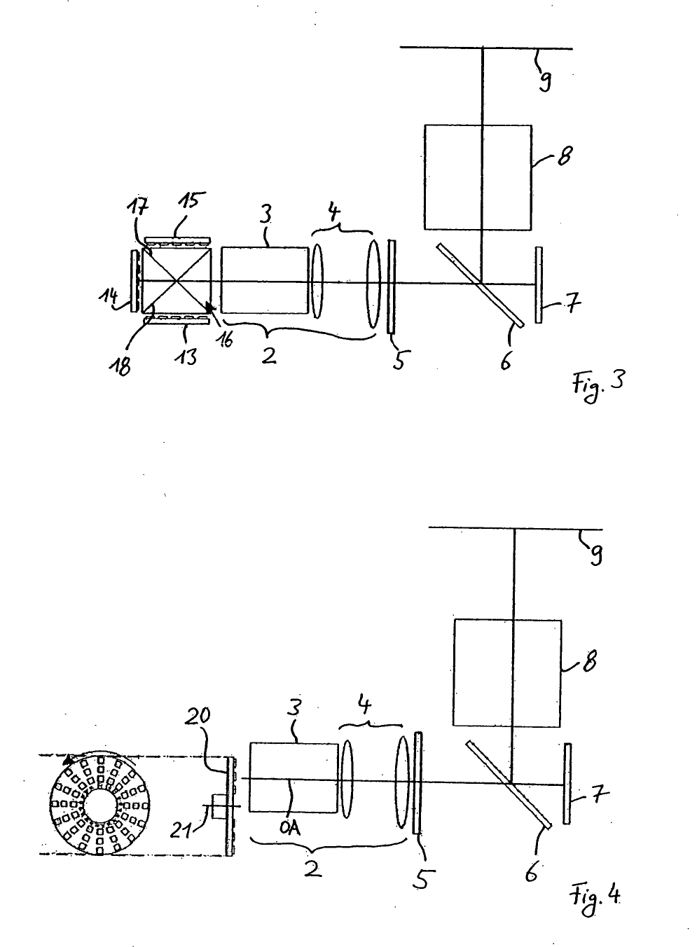

FIG. 4 shows a third embodiment of the projection device according to the invention, which differs from the embodied device shown in FIG. 1 insofar as a rotatable light emitting diode disk 20 is provided instead of the light emitting diode array 1. FIG. 4 shows a top view of the disk 20 on the left-hand side. The axis of rotation 21 of the light emitting diode disk 20 is offset relative to the optical axis OA of the illumination optics 2, so that, upon rotation of the light emitting diode disk 2, there are always other light emitting diodes placed in front of the illumination optics. These light emitting diodes are switched on during operation, so that (in the case of a segmented arrangement of red, green and blue light emitting diodes) red, green and blue light can be alternatingly directed onto the light modulator 6 via the illumination optics. Since the light emitting diodes on the light emitting diode disk 20 only have to be switched on once for a short time during each rotation, excessive thermal loads which might, in some cases, destroy the light emitting diodes can be avoided.

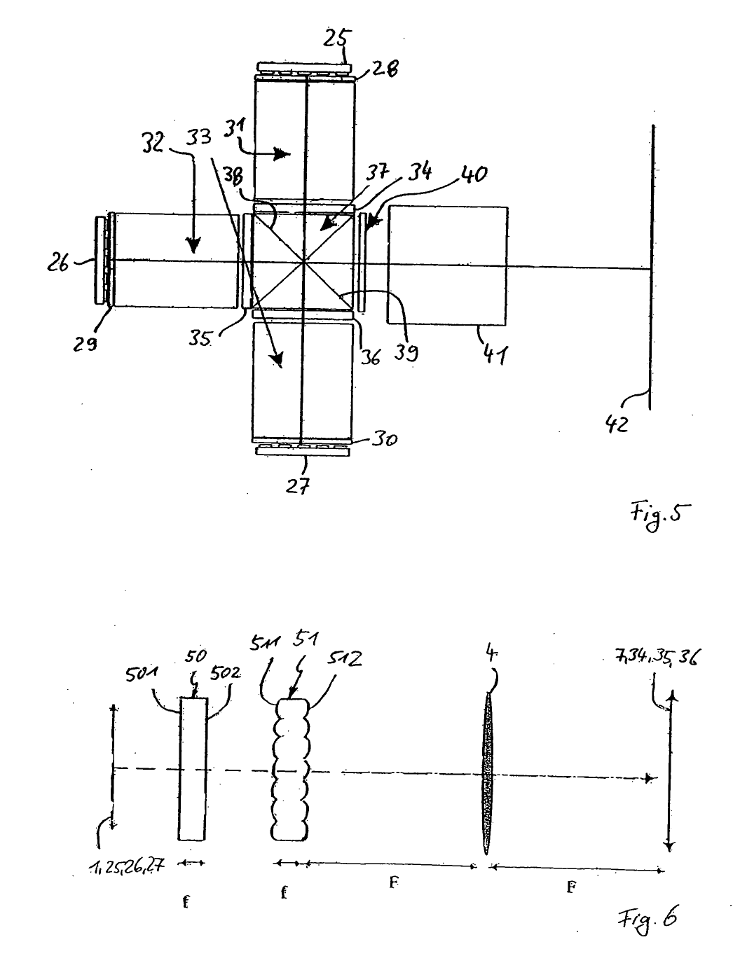

FIG. 5 shows a fourth embodiment of the projection device, wherein there are provided for each of the colors red, green and blue, respectively, an light emitting diode array 25, 26, 27, a polarizer 28, 29 and 30 arranged following it, as well as illumination optics 31, 32, 33 with a transmissive LCD module 34, 35 and 36 arranged following them. The LCD modules 34 to 36 are provided on three sides of a color-combining cube 37 with two color-splitting layers 38 and 39 which superimposes the partial color images of the LCD modules 34 to 36 upon one another. The superimposed partial color images are supplied by a polarizer 40, which only allows light for brightened pixels to pass, and are projected onto a projection surface 42 by means of projection optics 41 arranged following said polarizer 40. This arrangement allows the partial color images to be generated simultaneously, so that the projected multi-color image may be very bright.

FIG. 6 shows an embodiment of the illumination optics 2, 31, 32, 33 used in the above projection devices. The illumination optics comprise two tandem cylinder lens arrays 50, 51 followed by focussing optics 4 with positive refractive power. A tandem lens array as used herein means that one lens array 501, 502; 511, 512 each are arranged on the front and rear surfaces of a substrate, which are identical in this case and adjusted relative to each other. The substrate thicknesses of both tandem lens arrays 50, 51 are selected such that the focal points of the lenses of the respective lens array 501, 511 on the front surface are located in the principal plane of the lenses of the respective lens array 502, 512 on the rear surface of the substrate (focal length f). The lens arrays 50 and 51 are embodied as two crossed tandem cylinder lens arrays and are adapted to the surface of the light modulators 7, 34, 35, 36 to be illuminated.

The optical distance from the focussing optics 4 to the second lens array 502, on the one hand, and to the light modulator 7, 34, 35, 36, on the other hand, corresponds to the focal length F of the focussing optics 4. Thus, the illumination optics 2 are provided as a honeycombed condensor system enabling excellent, homogeneous illumination of the light modulators 7, 34, 35, 36. The cylinder lens arrays 50, 51 are preferably arranged such that they are rotated 90° relative to each other, thus alllowing adjustment of a desired rectangular aspect ratio (preferably that of the imaging regions of the light modulators). Of course, instead of said two cylinder arrays 50 and 51, it is also possible to provide just one single lens array or tandem lens array (not shown) which comprises lenses arranged in lines and columns and is provided such that the single lens array, in particular, has the same optical effect as said two tandem cylinder lens arrays 50, 51.

The present invention may be embodied in other specific forms without departing from the spirit of any of the essential attributes thereof; therefore, the illustrated embodiments should be considered in all respects as illustrative and not restrictive, reference being made to the appended claims rather than to the foregoing description to indicate the scope of the invention.

1. A projection device for projecting a multi-colored image, comprising a light source unit having a plurality of light-generating elements emitting light of different colors, a light modulator unit, illumination optics arranged between the light source unit and the light modulator unit and directing light from the light source unit onto the light modulator unit, projection optics arranged following the light modulator unit, said projection optics projecting an image generated by the light modulator unit onto a projection surface, wherein the light source unit comprises light emitting diodes as the light-generating elements.

2. The projection device as claimed in claim 1, wherein the light emitting diodes are arranged in an array.

3. The projection device as claimed in claim 1, wherein the light source unit comprises an array on which light emitting diodes emitting light of different colors are arranged.

4. The projection device as claimed in claim 1, further comprising a control unit which can control the light emitting diodes so that only light from some of the light emitting diodes is used for illumination of the light modulator unit at a given time.

5. The projection device as claimed in claim 4, wherein the light emitting diodes are movable relative to the illumination optics.

6. The projection device as claimed in claim 5, wherein the light emitting diodes are arranged on a rotatable carrier.

7. The projection device as claimed in claim 1, further comprising a control unit, capable of controlling the light emitting diodes such that light from only a portion of the light emitting diodes illuminates the light modulator unit at a given time, and a deflecting unit between the light emitting diodes and the illumination optics controlled by the control unit, to couple the light from different light emitting diodes into the illumination optics as time progresses.

8. The projection device as claimed in claim 1, wherein the light source unit comprises two light emitting diode arrays both emitting light in the same direction, the light emitting diode arrays being arranged one behind the other, as seen in the direction of light propagation, and imaging optics arranged between the two arrays, the imaging optics imaging the light emitting diodes of the first array between the light emitting diodes of the second array.

9. The projection device as claimed in claim 8, wherein the light emitting diodes of the second array are attached to a carrier plate having openings between the light emitting diodes, for passage of the light from the light emitting diodes of the first array.

10. The projection device as claimed in claim 1, wherein the light source unit comprises at least two light emitting diode light sources emitting light of different colors, and wherein the illumination optics comprise a combining unit which guides the light from the light emitting diode light sources in a common beam path leading to the light modulator unit.

11. The projection device as claimed in claim 1, wherein the light source unit comprises at least two light emitting diode light sources emitting light of different colors, and the light modulator unit contains a light modulator for each light emitting diode light source, with light from each respective light emitting diode light source being directed onto said light modulator, and further comprising, between the projection optics and the light modulators, a combining unit which guides the modulated light coming from the light modulators into a common beam path leading to the projection optics.

12. The projection device as claimed in claim 1, wherein the light modulator unit comprises at least one transmissive light modulator.

13. The projection device as claimed in claim 1, wherein the illumination optics comprise a first lens array and subsequently arranged optics having positive refractive power.

14. A projector for projecting multicolored images, comprising:
a light source comprising a plurality of light emitting diodes, the light emitting diodes emitting light in at least two different colors;
a light modulator unit;
illumination optics between the light source and the light modulator unit; and
projection optics following the light modulator unit to project an image generated at the light modulator unit onto a projection surface.

15. The projector as claimed in claim 14, in which the light emitting diodes are arranged in an array.

16. The projector as claimed in claim 14, further comprising a control unit capable of illuminating the different colored light emitting diodes sequentially such that the light emitting diodes of a first color are illuminated followed by the light emitting diodes of a second color.

17. The projector as claimed in claim 14, in which the light emitting diodes are movable relative to the illumination optics.

18. The projector as claimed in claim 14, further comprising a rotatable carrier upon which the light emitting diodes are supported.

19. The projection device as claimed in claim 14, further comprising a control unit, controlling the light emitting diodes such that light from only a portion of the light emitting diodes illuminates the light modulator unit at a given time, and a deflecting unit between the light emitting diodes and the illumination optics controlled by the control unit, to couple the light from different light emitting diodes into the illumination optics as time progresses.

20. The projection device as claimed in claim 14, wherein the light source unit comprises two light emitting diode arrays both emitting light in the same direction, the light emitting diode arrays being arranged one behind the other and imaging optics arranged between the two arrays, the imaging optics imaging the light emitting diodes of the first array between the light emitting diodes of the second array.

21. The projection device as claimed in claim 20, wherein the light emitting diodes of the second array are attached to a carrier plate having openings between the light emitting diodes, for passage of the light from the light emitting diodes of the first array.

22. The projection device as claimed in claim 14, wherein the illumination optics comprise a combining unit which guides the light from the light emitting diode light sources in a common beam path leading to the light modulator unit.

23. The projection device as claimed in claim 14, wherein the the light modulator unit contains a light modulator for each light emitting diode light source, with light from each respective light emitting diode light source being directed onto said light modulator, and further comprising, between the projection optics and the light modulators, a combining unit which guides the modulated light coming from the light modulators into a common beam path leading to the projection optics.

24. The projection device as claimed in claim 14, further comprising a deflection unit sequentially directing light from the light emitting diodes of different colors into the illumination optics.

25. A method of projecting a multicolored image, comprising the steps of:
illuminating a light source comprising a plurality of light emitting diodes, the light emitting diodes emitting light in at least two different colors;
directing the light via illumination optics to a light modulator unit; and
passing light from the light modulator unit into projection optics to project an image generated at the light modulator unit onto a projection surface.

26. The method as claimed in claim 25, further comprising the step of arranging the light emitting diodes in an array.

27. The method as claimed in claim 25, further comprising the step of controlling the light emitting diodes with a control unit capable of illuminating the different colored light emitting diodes sequentially such that the light emitting diodes of a first color are illuminated followed by the light emitting diodes of a second color.

28. The method as claimed in claim 25, further comprising the step of moving the light emitting diodes relative to the illumination optics.

29. The method as claimed in claim 25, further comprising the step of locating the light emitting diodes on a rotatable carrier.

30. The method as claimed in claim 25, further comprising the step of controlling the light emitting diodes such that light from only a portion of the light emitting diodes illuminates the light modulator unit at a given time, and a deflecting unit between the light emitting diodes and the illumination optics controlled by the control unit, to couple the light from different light emitting diodes into the illumination optics as time progresses.

31. The method as claimed in claim 25, further comprising the step of locating the light emitting diode arrays one behind the other and locating imaging optics between the two arrays, such that the imaging optics image the light emitting diodes of the first array between the light emitting diodes of the second array.

32. The method as claimed in claim 31, further comprising the step of attaching the light emitting diodes of the second array to a carrier plate having openings between the light emitting diodes, for passage of the light from the light emitting diodes of the first array.

33. The method as claimed in claim 25, further comprising the step of combining the light from the light emitting diode light sources in a common beam path leading to the light modulator unit.

34. The method as claimed in claim 25, further comprising the step of combining the light from the light emitting diode light sources in a common beam path leading to the light modulator unit modulating the light for each light emitting diode light source.

35. The method as claimed in claim 25, further comprising the step of sequentially deflecting light from the light emitting diodes of different colors into the illumination optics.
